(19) United States
(12) Patent Application Publication
(10) Pub. No.: US 2021/0039969 A1
(43) Pub. Date: Feb. 11, 2021

(54) Electrochemical Precipitation Reactor With a Moving Electrode

(71) Applicants: Eisenhuth GmbH & Co. KG, Osterode (DE); Technische Universitaet Clausthal, Clausthal-Zellerfeld (DE)

(72) Inventors: Ulrich Kunz, Osterode (DE); Thorben Muddemann, Clausthal-Zellerfeld (DE); Michael Sievers, Clausthal-Zellerfeld (DE); Dennis Haupt, Seesen (DE); Thorsten Hickmann, Osterode (DE); Rouven Henkel, Osterode (DE)

(21) Appl. No.: 17/073,539

(22) Filed: Oct. 19, 2020

Related U.S. Application Data
(63) Continuation of application No. PCT/EP2019/060345, filed on Apr. 23, 2019.

(30) Foreign Application Priority Data
Apr. 19, 2018 (DE) 10 2018 109 314.4

(51) Int. Cl. C02F 1/46; C02F 1/463; C02F 1/461

(52) U.S. Cl. CPC C02F 1/4602; C02F 1/463; C02F 1/46109; C02F 2201/46155; C02F 2001/46123; C02F 2001/46133; C02F 2001/46119

(57) ABSTRACT

In an electrochemical treatment of a liquid in a precipitation reactor, the liquid is brought into contact with an electrically conductive electrode and an electrically conductive counter-electrode. The electrically conductive electrode comprises a flexible area electrode essentially having a two-dimensional extension. An electric voltage is applied between the electrode and the counter-electrode. The flexible area electrode is repeatedly deformed perpendicularly to its two-dimensional extension to inhibit the accumulation of substances precipitated from the liquid on the electrode and to remove substances precipitated from the liquid and accumulated on the electrode from the electrode.

### CROSS REFERENCE TO RELATED APPLICATIONS

This application is a continuation to international application No. PCT/EP2019/060345 entitled “Electrochemical Precipitation Reactor with a moving Electrode”, filed on Apr. 23, 2019, and claiming priority to German patent application No. 10 2018 109 314.4 entitled “Elektrochemischer Fällungsreaktor mit bewegter Elektrode” and filed on Apr. 19, 2018.

### FIELD OF THE INVENTION

The present invention relates to electrochemical precipitation reactors and to a method of electrochemically treating a liquid.

### BACKGROUND OF THE INVENTION

In an electrochemical treatment of a liquid, the liquid is brought into contact with an electrically conductive electrode and an electrically conductive counter-electrode, and an electric voltage is applied between the electrode and the counter-electrode. The sign of the voltage applied between the electrode and the counter-electrode results in whether the electrode is active as a cathode or an anode in the electrochemical treatment. The electric voltage applied triggers chemical reactions in the liquid. These reactions, besides the composition of the liquid, depend on the height of the voltage applied and the material of the electrodes.

An electrochemical treatment of water may be carried out to reduce the calcium carbonate content of the water. Herein, a local alkalization of the cathode surface due to the water electrolysis is used to shift the calcium carbonate-carbonic acid equilibrium such that the calcium carbonate is precipitated at the cathode and may thus be removed from the water. However, relevant parts of the precipitating calcium carbonate are directly deposited on the cathode and thus cover the cathode with an isolating calcium carbonate layer so that the cathode loses its electrical conductivity. At least, the active surface of the cathode is reduced resulting in undesired high local current densities.

An electrochemical treatment of liquids may also have the purpose of purposefully oxidizing certain ingredients of the liquids. This oxidization may, for example, be carried out to degrade pharmaceuticals by which a waste water is loaded. Here, the desired oxidization can be enhanced by using certain materials for the electrodes. The use of boron doped diamond electrodes has proven to be advantageous. However, boron doped diamond electrodes are expensive and can only be used economically if very long service lives can be achieved. However, in the treatment of calcium carbonate containing waste waters, the service life of boron doped diamond electrodes, at least if used as cathodes, is limited, because calcium carbonate also precipitates at the boron doped diamond electrodes which can hardly be removed without damaging the electrodes even if higher effort is taken. Generally, there is the option to delay or reverse the calcification of electrodes by reversion of polarity so that the previous cathode becomes the anode and vice versa. However, such a reversion of polarity reduces the efficiency of the respective electrochemical treatment, it is not possible in all electrochemical reactors, and, on its part, it has a rather negative effect on the service life of boron doped diamond electrodes.

An apparatus and a method for the treatment of water against lime deposit by electrolytic formation of calcium carbonate crystals is known from European patent EP 1 002 765 B1. For this purpose, an electrolysis device comprising electrodes is used, between which a voltage is applied that is suitable for electrolytic dissociation of water. The electrodes include a brush-shaped cathode with bristles of a flexible material whose surface is continuously or at intervals moved by a torsional or bending motion with regard to the calcium carbonate crystals deposited on the cathode and thus causes their chipping-off. For this purpose, a stripper may be provided which at least partially meshes with the free ends of the bristles and which is moved relative to the bristles. With regard to the brush-shaped cathode whose elongated bristles are directed towards the anode, it is indicated that comparatively high electrical field strengths of the electrolytic field result at the tips, and that, thus, calcium carbonate crystals are predominantly formed and precipitated at the tips of the bristles. In fact, however, such an inhomogeneous distribution of the electrolytic field and a concentration of the electrochemical reactions to a small part of the surface of the cathode resulting therefrom are disadvantageous, inter alia because the cathode may in this way be excessively stressed locally instead of being active over its entire surface.

From R. Kraft et al.: Electrochemical water disinfection Part III: Hypochlorite production from potable water with ultrasound assisted cathode cleaning, Journal of Applied Electrochemistry 32, 597-601, 2002 it is known to avoid or remove the deposit of calcium carbonate on the surface of a cathode of an electrochemical reactor used for water disinfection by ultrasound. Here, the cathode is used as a sonotrode which is excited for vibrations at a frequency of 24 kHz by an ultrasound transducer. The cathode is made of an expanded metal of titanium coated with ruthenium oxide. The excitation of the cathode for ultrasound vibrations may be continuous or intermittent. In any case, the ultrasound vibrations result in a mechanical stress to the reactor which affects its service life.

A flexible conductive plastic electrode is known from U.S. Pat. No. 5,665,212 and European patent EP 0 658 277 B1 belonging to the same patent family. The electrode includes a flexible conductive plastic material and a further electrode component which is a metal mesh, a metal sheet, a metal foil or a graphite felt. The plastic material includes a conductive filler material and a thermoplastic polymer having a moderate to high crystallinity and a glass transfer temperature above the operating conditions of the electrode, and an elastomeric polymer. The plastic material has a specific resistivity of not more than 4.000 Ohm×cm. The electrode is flexible and has a high tensile strength. The further electrode component is pressure and heat welded and arranged on at least one surface of the flexible conductive plastic material, or it is arranged as a metal foil or metal mesh between two layers of the conductive plastic material. The filler material may be carbon black, graphite, metal powder, metalized glass fibers, or carbon fibers. The carbon black may include different carbon black types, namely fine carbon black powder having a particle size of 2 to 35 nm and coarse metal powder having a particle size of 35 to 10.000 nm. The thermoplastic polymer may be low density polyethylene, polypropylene, polybutylene or polystyrene. The known electrode may be used as a cathode or anode in an all vanadium redox battery, wherein the electrode is in contact with an anolyte or a catholyte.

A method of electrochemically treating a solution containing a certain material, and an electrochemical cell for carrying out the method are known from UK patent application publication GB 20 75 061 A and German patent application publication DE 30 20 475 A1 belonging to the same patent family. The solution is brought into contact with one side of a porous, bipolar barrier electrode under such electrochemical conditions that the material reacts and produces a product. The product is deposited on this one side but passes through the porous, bipolar barrier electrode onto its other side. In a second solution on the other side of the barrier electrode, the product reacts to produce a second product. The porous, bipolar barrier electrode is grounded, and it is on a first predetermined electrical potential with regard to a reference electrode in the solution on its one side and on a second predetermined electrical potential with regard to a reference electrode in the second solution on its other side. The porous, bipolar barrier electrode consists of a porous electrically conductive material in form of an expanded metal sheet or another conductor material carried by a porous and non-conductive material. A periodical variation of the predetermined electrical potentials on both sides of the porous barrier electrode by, for example, applying a tipping pulse or any other suitable wave form may result in an advantage with regard to a removal of foreign particles out of the barrier electrode. The solutions may be moved by means of sound in that they are excited by means of a vibrating transducer of controlled amplitude and frequency. It is a further option to induce hydraulic impulses by means of an intermittent valve system or via a driven piston. The known method can be used for removing heavy metals from waste waters, sewages and sludge, or for carrying out synthetically chemical reactions.

A method of cleaning and/or disinfecting metallic water pipes in which a flexible metal electrode is inserted in the pipe to be treated and a direct voltage superimposed with a pulse voltage of opposite polarity is applied between the pipe and the metal electrode is known from German patent application publication DE 23 50 078 A1. The flexible metal electrode is surrounded by a flexible tube-shaped diaphragm made of a porous material, preferably made of plastic. The flexible metal electrode is inserted into the tube to be cleared from deposits and/or to be disinfected in that it is pulled in by means of a tag line or injected by pressurized air or installed by jetting. In order to avoid that the flexible metal electrode and the diaphragm touch the pipe wall, separators are provided. By means of the direct voltage applied between the pipe and the metal electrode, scaling and deposits adhering to the pipe are detached, wherein the cations migrate through the diaphragm to the flexible electrode, where they are removed by flushing water with which the tube-shaped diaphragm is flushed.

A metal ion sterilization device having two cone-shaped electrodes arranged one within the other and an isolating holder arranged in between is known from international patent application publication WO 2012/ 053 736 A2, its German translation published as DE 11 2011 103 131 T5 and US patent application publication US 2013/0 206 664 A1 all belonging to the same patent family. The isolating holder is turnable with regard to the electrodes about their coincident cone axes and comprises brushes which remove foreign particles in that they rub against the opposing outer and inner surfaces of the cone-shaped electrodes.

A method of electrochemically treating inner surfaces of large vessels is known from U.S. Pat. No. 3,857,764. For this purpose, an electrode device comprising a pair of copper mesh electrodes which are arranged on an inflatable plastic bag and which, by means of inflating the plastic bag within the respective vessel, can be arranged adjacent to the wall of the vessel.

There still is a need of an electrochemical precipitation reactor, of a method for electrochemical treatment and of a use of this precipitation reactor for executing this method, in which it is avoided by simple means that the electrode is inactivated by precipitated substances so that the life time of the electrode and the entire precipitation reactor is maximized.

### SUMMARY OF THE INVENTION

The present invention relates to an electrochemical precipitation reactor comprising a deformable electrically conductive electrode which gets into contact with the liquid to be treated in the precipitation reactor and which comprises a flexible area electrode essentially having a two-dimensional extension. The precipitation reactor further comprises deformation devices configured to repeatedly deform the electrode perpendicular to its two-dimensional extension to inhibit an accumulation of substances precipitated from the liquid on the electrode and to remove substances precipitated from the liquid and accumulated on the electrode from the electrode.

The present invention further relates to a electrochemical precipitation reactor comprising an electrically conductive electrode. The electrode comprises a flexible area electrode essentially having a two-dimensional extension, which gets into contact with a liquid to be treated in the precipitation reactor. The flexible area electrode includes a plastic matrix with embedded electrically conductive particles, and the flexible area electrode has a smoothly formed surface there, where it gets into contact with the liquid to be treated in the precipitation reactor.

The present invention further relates to a method of electrochemically treating a liquid. The method comprises the steps of bringing the liquid into contact with an electrically conductive electrode and an electrically conductive counter-electrode, the electrically conductive electrode comprising a flexible area electrode essentially having a two-dimensional extension; applying an electric voltage between the electrode and the counter-electrode; and repeatedly deforming the flexible area electrode perpendicularly to its two-dimensional extension to inhibit the accumulation of substances precipitated from the liquid on the electrode and to remove substances precipitated from the liquid and accumulated on the electrode from the electrode.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components of the drawings are not necessarily to scale, emphasize instead being placed upon clearly illustrating the principles of the present invention. In the drawings, like reference numerals designate corresponding parts throughout the several views.

FIG. 1 shows an apparatus comprising a precipitation reactor according to the invention for an electrochemical treatment of a liquid.

FIG. 2 shows a further apparatus comprising a further embodiment of the precipitation reactor according to the invention, which is arranged in the forerunning of a further electrochemical reactor for a further electrochemical treatment of a liquid pretreated in the precipitation reactor.

FIG. 3, as a detail of a precipitation reactor according to the invention, shows an area electrode which, by means of deformation devices, is deformed perpendicularly to its two-dimensional extension.

### DETAILED DESCRIPTION

In an electrochemical precipitation reactor according to the invention and comprising a deformable electrically conductive electrode which gets into contact with a liquid to be treated in the precipitation reactor, and deformation devices for repeatedly deforming the electrode to inhibit the accumulation of substances precipitated from the liquid on the electrode and/or to remove substances precipitated from the liquid and accumulated on the electrode from the electrode, the electrode comprises a flexible area electrode having a two-dimensional extension, and the deformation devices are configured to deform the area electrode perpendicular to its two-dimensional extension.

That the electrically conductive electrode gets into contact with the liquid to be treated in the precipitation reactor means that the electrically conductive electrode adjoins a reaction space of the electrochemical precipitation reactor according to the invention which receives the liquid to be treated.

Here, an area electrode is to be understood as an electrode that essentially extends along an area which is not necessarily plane and that, thus, has two main surfaces. The area along which the area electrode extends is also designated as its area of main extension here. The area electrode only has a comparatively little extension perpendicular to its area of main extension. As a rule, this little extension is not more than 20%, typically not more than 15%, in many cases not more than 10% and often not more than 5% of the shortest extension of the area electrode along its area of main extension. Often, the not yet deformed area electrode is plane, and it has plane main surfaces extending in parallel to a plane of main extension.

Transverse to its two-dimensional extension, the area electrode may be completely closed, i.e. have no openings, cross channels or open porosity. Alternatively, the area electrode may have a limited permeability for the liquid to be treated transverse to its two-dimensional extension. Then, an area portion of the area electrode which is permeable to the liquid to be treated amounts to not more than 67%, preferably to not more than 50%, more preferably to not more than 33% and even more preferably to not more than 25%.

The area electrode is deformed perpendicular to its two-dimensional extension by means of the deformation devices. In other words, at least one region is moved with regard to at least one other region of the area electrode perpendicularly to its area of main extension. In doing so, the deformation devices may excite the area electrode for vibrations. These vibrations may be forced or resonant vibrations of the area electrode. However, this is not mandatory for the present invention, even if the excitation of the area electrode at its resonance frequency for an eigen-vibration may have energetic advantages. These energetic advantages relate to the energy which has to be spent to realize a certain number of deformations with a certain amplitude. In any case, the vibrations of the area electrode are dampened by the liquid to be treated in the electrochemical precipitation reactor, which is in contact with the electrode. The electrode deformed perpendicular to its two-dimensional extension, i.e. to its area of main extension, also has an effect on the electric field formed in the electrochemical precipitation reactor. However, the area electrode of the electrochemical precipitation reactor according to the invention is effective over its entire area and not only punctually as no field centers are formed even at the deformed flexible area electrode.

This implies that the area electrode is not equipped with bristles or the like in the electrochemical precipitation reactor according to the invention. On the contrary, the entire electrode is, as a rule, not structured, and there where it gets into contact with the liquid to be treated in the precipitation reactor the area electrode has an as smooth as possible surface. In combination with the deformations of the electrode, this smooth surface avoids an accumulation of the substances precipitated from the liquid, and it also eases the removal of the accumulated substances by deforming the electrode. Preferably, both the desired smooth surface of the electrode and an easy deformability of the area electrode are achieved in that the area electrode includes a flexible plastic matrix with small embedded electrically conductive particles.

It emerged from the practice of application that an area electrode which includes a plastic matrix with embedded electrically conductive particles and which has a smoothly formed surface there where it gets into contact with the liquid to be treated in the reaction reactor does not tend to accumulation of substances precipitated from the liquid such that the electrode is inactivated even without repeated deformation during its use in an electrochemical precipitation reactor. This also and especially applies, if such an electrode is used as a cathode in an electrochemical precipitation reactor for precipitating calcium carbonate from water. A smoothly formed surface is particularly be understood as such a surface which has been created by forming the area electrode in a forming tool with smooth interior surfaces.

Particularly, the plastic matrix may be based on a thermoplastic elastomer (TPE), and the electrically conductive particles may be based on carbon. The thermoplastic elastomer may particularly be selected from a group including the following substances: thermoplastic copolyamides (TPE-A), thermoplastic copolyesters (TPE-E), thermoplastic polyolefinelastomers (TPE-O), particularly PP/EPDM, styrenic block copolymers (TPE-S), like SBS, SEBS, SEPS, SEEPS and MBS, thermoplastic polyurethanes (TPE-U), thermoplastic vulcanizates (TPE-V) and cross linked thermoplastic polyolefinelastomers.

By means of the embedded electrically conductive particles, electric resistances of the area electrode are adjusted, which are typically smaller than 0.05 Ohm*cm or even better smaller than 0.03 Ohm*cm and for example 0.027 Ohm*cm at the surface of the area electrode, and which are typically smaller than 1.0 Ohm*cm or even better smaller than 0.6 Ohm*cm and, for example, 0.5 Ohm*cm in a passage through the area electrode.

The particles may be carbon black or graphite particles or other unshaped particles on carbon base as well as carbon nanotubes (CNTs) whose particle size does not exceed 2.000 μm, preferably 1.500 μm, most preferably 1.000 μm. It is easier to distribute comparatively small particles in the plastic matrix without compromising its mechanical property.

Further, the electrically conductive particles embedded in the plastic matrix may be fibers based on carbon, particularly pure carbon fibers. Generally, fibers which only serve for mechanically reinforcing the plastic matrix and which are not electrically conductive, for example glass fibers may also be embedded in the plastic matrix.

Additionally, catalyzer particles may be embedded in the plastic matrix or generally in the area electrode and/or arranged on the surface of the area electrode where the area electrode gets into contact with the liquid to be treated in the precipitation reactor. Catalyzer particles are particularly to be understood as particles of an electrochemically active catalyzer which promotes desired electrochemical reactions at the electrode, for example an oxygen reducing catalyzer for avoiding the formation of hydrogen at the cathode.

To be able to more strongly deform the area electrode even with a limited force, the modulus of elasticity of the material of the area electrode should not be too high. A modulus of elasticity between 100 MPa and 200 MPa or particularly between 140 MPa and 190 MPa has proven to be advantageous. With regard to the Shore-hardness of the material of the area electrode comprising a flexible plastic matrix, a hardness of 90 to 100 Shore A and particularly of 95 to 100 Shore A may be advantageous. A thickness of the area electrode is typically 0.5 to 3 mm in absolute measures and typically 0.5% to 3% of its maximum extension along its two-dimensional extensions in relative measures.

Preferably, the deformation devices of the precipitation reactor according to the invention are configured such that they repeatedly bend the area electrode through by at least 4 mm or even 8 mm or by at least +/−2 mm or even +/31 4 mm related to an extension of the area electrode along its two-dimensional extension of 100 mm. These are macroscopic amplitudes. As a rule, the deformation devices of the precipitation reactor according to the invention will bend the area electrode through by not more than 40 mm, typically by not more than 20 mm and often by not more than 10 mm or by not more than +/−20 mm, by not more than +/−10 mm or by not more than +1/−5 mm related to its extent along its area of main extension. Here, a bending of +/−x mm means that the bendings follow to each other in opposite directions starting from an unbent base position of the area electrode at both a positive and a negative amplitude of x mm, whereas a bending of x mm indicates that the bendings only take place in one direction at an amplitude of x mm.

Particularly, the area electrode can be clamped fix in two border regions opposing each other across a force application point, and the deformation devices may be configured to engage the area electrode in the force application point to move the force application point in transverse direction to the area of main extension of the area electrode. Generally, the area electrode may also be clamped fix at its entire outer circumference.

For moving the force application point of the area electrode, the deformation devices may particularly comprise an electromagnetic actuator. Then, a movable part of the electromagnetic actuator is integrated in the area electrode or coupled thereto, and it is moved with regard to an unmovable part of the actuator when operating the actuator. By means of an electromagnetic actuator, the deformation devices can deform the area electrode in a large range of frequencies. Particularly, the deformation devices can be configured to periodically deform the area electrode at a frequency between 1 Hz and 20 kHz, preferably between 10 Hz and 10 kHz and even more preferred between 50 Hz and 1 kHz. The periodic deformation needs not to take place continuously but it may already be interrupted after a few deformations to be started again at intervals. These intervals may be empirically defined in such a way that the energetic input for deforming the area electrode is minimized and that nevertheless a permanent accumulation of substances precipitated from the respective liquid on the area electrode is avoided.

Although there may be other embodiments of the precipitation reactor according to the invention in which an alternative voltage with regard to earth is applied to the electrode and a virtual counter-electrode for the electrode is formed by the electric capacity of the liquid to be treated, the precipitation reactor according to the invention, as a rule, has a real counter-electrode for the electrode. This counter-electrode may be a further flexible area electrode with two-dimensional extension. The deformation devices may also deform this further area electrode perpendicular to its two-dimensional extension. Whether this is suitable or even necessary depends on whether, in the operation of the precipitation reactor, depending on the sign of the voltage applied between the electrode and the counter-electrode, substances, also at the counter-electrode, precipitate from the liquid to be treated and are potentially deposited on the area electrode. Besides the sign of the voltage, this particularly depends on the composition of the liquid to be treated. If the sign of the voltage between the electrode and the counter-electrode alters, it is in any case suitable to configure and, if necessary, to also deform the counter-electrode in the same way as the electrode. However, it is also possible to provide another electrode, for example a boron doped diamond electrode as a counter-electrode to the flexible area electrode according to the invention. Particularly, such a boron doped diamond electrode may be provided as an anode opposite to an area electrode according to the invention used as a cathode at which the tendency to calcification is present.

In the precipitation reactor according to the invention, a semipermeable membrane may be arranged between the area electrode and the counter-electrode. The semi-permeable membrane may, for example, be only permeable to protons. In any case, the semi-permeable membrane as such is preferably not electrically conductive. Thus, the semi-permeable membrane, even with stronger deformations of the area electrode, ensures that the electrode and the counter-electrode do not touch each other causing a shorter circuit fault. In other words, the semi-permeable membrane serves as a separator between the electrode and the counter-electrode. That no short circuit current flows between the electrode and the counter-electrode while deforming, even if the electrode and the counter-electrode touch each other, may be avoided in that a voltage present between the electrode and the counter-electrode is switched off while deforming.

In the precipitation reactor according to the invention, the area electrode can be arranged in such a way with regard to a liquid guidance of the precipitation reactor that it only gets into contact with the liquid to be treated at one side. Generally, the area electrode may also form a lateral wall of the precipitation reactor. However, it is preferred that the area electrode is arranged with regard to the liquid guidance of the precipitation reactor in such a way that the area electrode gets into contact with the liquid to be treated in the precipitation reactor at both of its main surfaces. This means that the area electrode, with both of its main surfaces, adjoins to partial spaces of a reaction space of the precipitation reactor.

The area electrode may be arranged with regard to a liquid guidance of the precipitation reactor in such a way that the area electrode, if the deformation devices repeatedly deform the area electrode perpendicular to its two-dimensional extension, pumps the liquid to be treated in the precipitation reactor according to the principle of a membrane pump. The area electrode moved in the liquid with its deformations may, thus, purposefully be used to circulate the liquid within the precipitation reactor, or, in combination with, for example, a one way valve, to pump the liquid through the precipitation reactor according to the principle of a membrane pump. Said in even other words, the area electrode may be the pump membrane of a membrane pump of the precipitation reactor according to the invention.

In a method according to the invention for an electrochemical treatment of a liquid, in which the liquid is brought into contact with an electrically conductive electrode and an electrically conductive counter-electrode, in which an electric voltage is applied between the electrode and the counter-electrode, and in which the electrode is repeatedly deformed to avoid an accumulation of substances precipitated from the liquid and/or to remove substances precipitated from the liquid and accumulated on the electrode from the electrode, a flexible area electrode of the electrode is deformed perpendicular to its two-dimensional extension in the step of deforming. With this deformed area electrode, the accumulation of the precipitated substances is avoided, even if a sign of the electric voltage applied between the electrode and the counter-electrode remains constant. This particularly applies if the area electrode is repeatedly bent in the step of deforming by at least 2 mm, 4 mm or even 8 mm or in alternating directions by at least +/−1 mm, +/−2 mm or even +/−4 mm as related to an extent of the area electrode along its two-dimensional extension of 100 mm. This means that, related to an extent of 100 mm, the area electrode is typically bent centrally by a measure in a range from 1 to 10 mm, i.e. moved perpendicular to its area of main extension. If here, in the context of the typical measure of the bending, reference is made to an extent of the area electrode along its two-dimensional extension of 100 mm, this does not mean that the area electrode has to have such an extent. Instead, its extent along its two-dimensional extension may be smaller or larger. Then, the typical bendings are also correspondingly smaller or larger, wherein they may vary not only linearly but also on a lower level with the extents of the area electrode. The deforming and particularly the bending of the area electrode may take place periodically at a frequency between 1 Hz and 10 kHz, preferably between 10 Hz and 10 kHz and even more preferred between 5 Hz and 1 kHz.

A sign of an electric voltage applied between the electrode and the counter-electrode may remain the same or change at a frequency of not more than 100 Hz, preferably of not more than 10 Hz, more preferred of not more than 1 Hz and most preferred of not more than 0.1 Hz. This means that the voltage applied is, as a rule, a direct voltage or a low frequency alternating voltage. Often, the voltage is a direct voltage of constant height.

The method according to the invention may efficiently be carried out using a precipitation reactor according to the invention. This use may particularly take place for pretreatment of the respective liquid before, in a further processing device, it is brought into contact with further electrodes, with heating elements transferring heat to the liquid, with catalyzers and/or with filter elements, which tend to that substances precipitated from the liquid, particularly calcium carbonate from water, accumulate on or in them in an undesired way and affect their function. Thus, the precipitation reactor according to the invention may, for example, be arranged as a protection reactor upstream of an electrochemical reactor, in which boron doped diamond electrodes are arranged for electrochemically degrading pharmaceutics in waste waters, to protect these boron doped diamond electrodes against calcification. If the precipitation reactor is arranged as a protection reactor upstream of a filter element, this filter element means no filter by which the precipitation products precipitated in the precipitation reactor according to the invention are separated from the respective liquid but a filter element which is arranged downstream of such a filter. This filter element may have a fine-pore and/or semi-permeable membrane through which the liquid pretreated in the precipitation reactor according to the invention passes without obstructing the membrane quickly with, for example, calcium carbonate.

If the precipitation reactor is arranged upstream of a further processing device as a protection reactor, the liquid to be treated may be passed once or several times through the protection reactor until the concentration of the substance to be reduced by precipitation is reduced to such an extent that the solubility limit is no longer exceeded at the functional surfaces of the further processing device. The liquid may at first be treated batch-vice in the precipitation reactor before it is afterwards supplied to the further processing device.

A parallel treatment with circulating the liquid to be treated through the precipitation reactor and the further processing device allows for a complete treatment of the liquid up to target values which shall be achieved in the treated liquid.

With a further processing device operating according to a method with concentration increasing properties, like, for example, a membrane method, an absorption method, a distillation method or a stripping method, as a rule, two output streams result from one input stream. A preferred embodiment of the use of the precipitation reactor according to the invention includes a feedback of the liquid phase of increased concentration into the precipitation reactor. Due to the increase of concentration, the liquid once again gets close to the solubility limit. Exceeding the solubility limit, which would result into scaling-effects like accumulations and crusting, which, for example, may lead to membrane damages in membrane methods, are avoided by integrating the precipitation reactor into the concentrate circuit. Thus, a higher level of increase of concentration and thus a higher yield of processed liquid are possible.

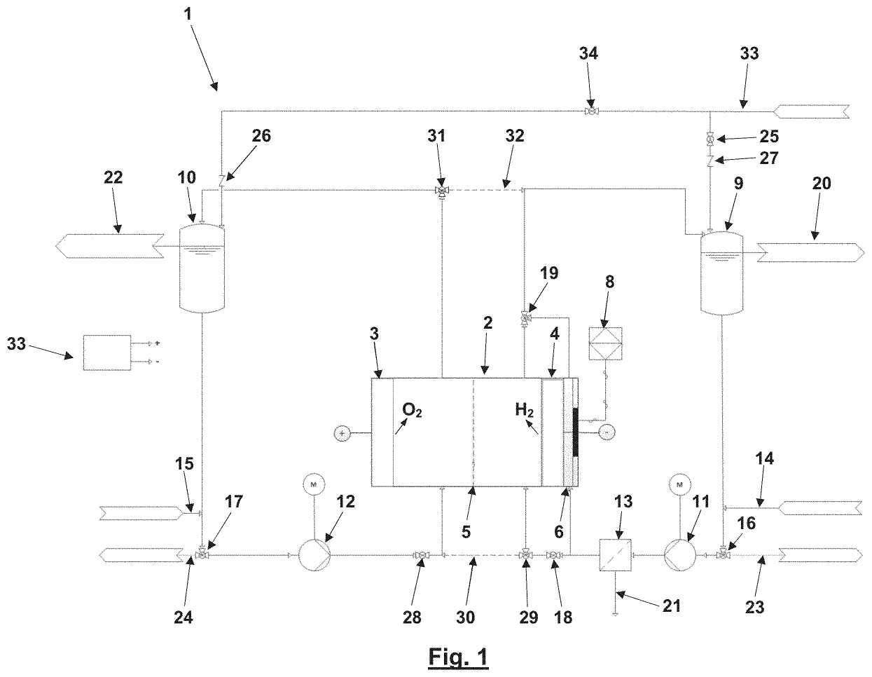

Now referring in greater detail to the drawings, the apparatus 1 depicted in FIG. 1 includes a precipitation reactor 2 as a core component, in which a liquid to be treated gets into contact with an electrode 4 and a counter-electrode 3. The electrode 4 and the counter-electrode 3 are connected to a minus pole and a plus pole of a voltage source 35 so that the electrode 4 is active as a cathode and the counter-electrode 3 is active as an anode. A separator 5 in form of a semi-permeable membrane is arranged between the electrode 4 and the counter-electrode 3. Between the separator 5 and the counter-electrode 3, on the one hand, and between the separator 5 and the electrode 4 and through a back space 6 on the back side of the electrode 4 facing away from the separator 5, on the other hand, liquid to be treated flows through the precipitation reactor 2. Partial streams of the same liquid or different liquids may flow through the mentioned partial spaces of the precipitation reactor 2. The partial spaces adjoining the electrode 4 such that a liquid flowing through these partial spaces gets into contact with the electrode 4 are also designated as parts of a reaction space of the precipitation reactor 2 here. According to FIG. 1, a liquid is supplied via an inlet 14, a pump 11 and a filter 13, wherein a valve 16 which can be switched to an outlet 23 is provided stream up of the pump 11, and wherein the supply of the liquid to the partial areas of the precipitation reactor 2 can be adjusted by means of further valves 18 and 29. Via the valve 29 and a bypass 30, the liquid supplied via the inlet 14 may also be forwarded to the anode 3. Alternatively, a further liquid can be supplied to the anode 3 via a further inlet 15, a further pump 19 and a valve 28. A valve 17 upstream of the pump 12 can be switched over to an outlet 24. At a valve 19, the streams of the liquid over the front side and the back side of the cathode 4 are merged, and from there they get into a container from which a product 20 can be taken. Further, the liquid may once again be circulated by means of the pump 11 out of the container 9 through the precipitation reactor 2 along the cathode 4. By means of a valve 31 via a bypass 32, liquid passing through the precipitation reactor 2 at the front side of the anode 3 may also be supplied to the container 9 or alternatively to a further container 10 out of which a further product 22 may be taken. Further, the liquid can be circulated once again through the precipitation reactor 2 out of the container 10 by means of the pump 22. Whereas it is depicted here that parallel flows flow through the precipitation reactor on both sides of the membrane 2, counter current flows are also possible. With regard to the liquid which flows through the precipitation reactor 2 on the anode side and which may also be designated as an anolyte, and the liquid which flows through the precipitation reactor 2 on the cathode side and which may thus also be designated as a catholyte, the apparatus 1 as depicted in FIG. 1 may be operated in different ways. The anolyte and the catholyte may be guided in a common circuit through the precipitation reactor 2. The anolyte may be guided in a closed circuit through the precipitation reactor 2, whereas the anolyte, separately therefrom, may be guided through the precipitation reactor 2 once or several times in an open circuit. It is also possible to guide the anolyte and the catholyte separately and independently from one another through the precipitation reactor 2 once or several times in an open circuit.

In the precipitation reactor 2, an electrolysis of water may occur which is a component of the liquid or liquids to be treated. To avoid reaching the lower explosion limit by the oxygen set free at the anode and/or by the hydrogen set free at the cathode 4, air or nitrogen 23 may be supplied to the containers 10 and 9 via valves 25 and nonreturn valves connected in series with the valves 25. The nonreturn valves 26 and 27 avoid the entrance of oxygen or hydrogen into the diluting gas used.

The precipitation reactor 2 may be used for inducing different electrochemical reactions which result in precipitating substances from the liquid to be treated at the anode 3 and/or at the cathode 4. To avoid an accumulation of these substances on the anode 3 or on the cathode 4, the anode 3 and the cathode 4 are configured as area electrodes with smooth surface made of a plastic matrix with embedded electrically conductive particles. At the smooth surfaces of these area electrodes, substances precipitated from the liquid accumulate in much smaller portions than on electrodes of common materials, like for example metal meshes. Thus, the substances precipitated from the liquid in the precipitation reactor 2 are removed with the liquid, and the filter 3 may separate them as precipitates 21. The filter 3, which is arranged in the inlet to the precipitation reactor 2 here, may also be arranged in its outlet, and there may also be several separate filters for the anolyte and the catholyte.

A special application of the apparatus 1 is to decalcify water. Herein, the water may be circulated through the precipitation reactor 2 only as the catholyte or also as the anolyte. Calcium carbonate is locally precipitated at the cathode surface at which an excessive OH⁻ ion concentration is formed, both at the front side and at the back side of the cathode 4. In addition to the smooth surface of the cathode 4, an inactivation of the cathode 4 by accumulating calcium carbonate is avoided in that the cathode 4 is repeatedly macroscopically deformed by means of deformation devices 7 and 8 in form of a solenoid 7 connected to an AC voltage source 8. These repeated macroscopic deformation of the cathode 4 is possible with a suitable flexible configuration of its plastic matrix. Due to the macroscopic deformation of the cathode 4 in which a bending of the cathode 4 related to an extent of the cathode 4 along its two-dimensional extension of 100 mm can be 8 mm or +/−4 mm, calcium carbonate already deposited on the cathode 4 comes off the electrode 4, this coming off, beside the deformation, also being eased by the smooth surface of the cathode 4. For example, the solenoid 7 of the deformation devices 7, 8 acts upon a permanent magnet integrated in the cathode 4 or mechanically coupled to the cathode 4, and thus exerts a magnetic force which bends the cathode 4 towards the separator 5 or away from the separator 5 depending on the current flow direction through the solenoid.

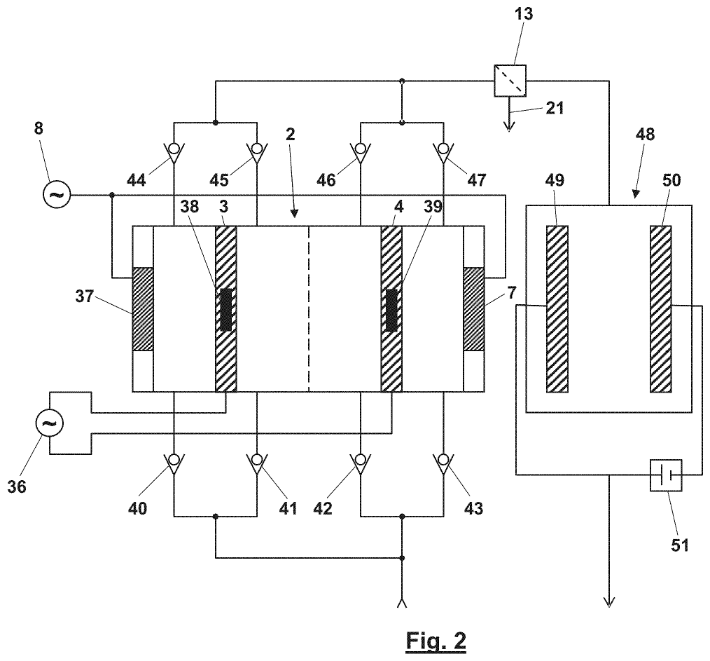

In testing of the precipitation reactor 2 for decalcification of water, a slightly reduced cell voltage and a nearly identical decalcification efficiency with regard to the catholyte resulted at a same current between the anode 3 and the cathode 4 as compared to a boron doped diamond electrode. At the same time, a calcium carbonate deposit on the surfaces of the cathode with the plastic matrix reduced to about 50% could be noticed. By means of the repeated deformation of the cathode 4 comprising the flexible plastic matrix, the calcium carbonate deposits could significantly be reduced further, and, thus, the service life of the cathode 4 could be prolonged. The embodiment of the precipitation reactor 2 according to FIG. 2 is symmetric with regard to the separator 5. This means that both electrodes 3, 4 are deformable by means of deformation devices 7, 8, 37 to 39. Further, the respective electrode 3, 4 is arranged centrally between the separator 5 and the side wall of the precipitation reactor 2 in which the solenoid 7 or 37 is arranged which acts upon the permanent magnet 39 or 38 embedded in the respective electrode. In combination with the nonreturn valves 40 to 47, the electrodes 3, 4 deformed by means of the deformation devices 7, 8, 37 to 39 have the effect of membrane pumps on the liquid to be treated and forward the liquid to be treated through the precipitation reactor 2. Here, the anolyte is identical to the catholyte, and instead of a direct voltage from the direct voltage source 35 according to FIG. 1, a low frequency alternating voltage from an alternating voltage source 36 is applied between the electrodes 3 and 4 which are thus alternately active as an anode and a cathode. To avoid the generation of a difference pressure over the separator 5, the electrodes 3 and 4 can be deformed in opposite directions, i.e. either bent towards or away from each other. According to FIG. 2, the precipitation reactor 2 is provided as a protection reactor for a further reactor 48 for an electrochemical treatment of the liquid. In the further reactor 48, for example, boron doped diamond electrodes 49 and 50 are provided as an anode and a cathode and connected to a direct voltage source 51 to degrade pharmaceuticals included in a waste water. In this case, the precipitation reactor 2 used as a protection reactor serves for precipitating calcium carbonate from the waste water which may then be separated by means of the filter 13 to avoid an inactivation of the electrodes 49 and 50 by accumulating calcium carbonate and to thus considerably increase their service lives.

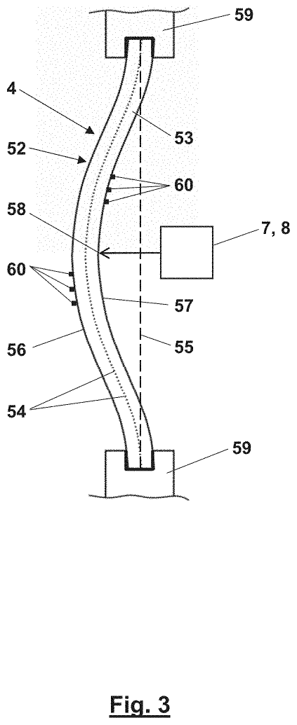

FIG. 3, at an enlarged scale, schematically depicts an area electrode 52 of the electrode 4 deformed by the deformation devices 7, 8. Particularly, the area electrode 52 clamped fix at its outer circumference in clamps 59 is deformed by engagement at a central force application point 58 perpendicular to its two-dimensional extension which is indicated by a dashed line 55. The area electrode 52 has the plastic matrix 53 in which the electrically conductive particles 54 are embedded and at whose surfaces 56 and 57 catalyzers 60 which are also particularly shaped may be arranged. The plastic matrix 53 is flexible to such an extent that it tolerates the deformations by means of the deformation devices 7, 8, but nevertheless sufficiently electrically conductive due to the embedded electrically conductive particles 54 such that it is useable as an electrode 4 in the precipitation generator 2 according to FIGS. 1 and 2. At its main surfaces, i.e. the surfaces 56 and 57, which get into contact with the liquid to be treated in the precipitation reactor 2 the area electrode 52 is formed smoothly to inhibit the attachment of substances precipitated from the liquid to be treated and to ease the removal of such attachments by deforming the area electrode 52 according to FIG. 3, respectively.

Many variations and modifications may be made to the preferred embodiments of the invention without departing substantially from the spirit and principles of the invention. All such modifications and variations are intended to be included herein within the scope of the present invention, as defined by the following claims.

We claim:

1. An electrochemical precipitation reactor comprising
a deformable electrically conductive electrode which gets into contact with the liquid to be treated in the precipitation reactor and which comprises a flexible area electrode essentially having a two-dimensional extension, and
deformation devices configured to repeatedly deform the electrode perpendicular to its two-dimensional extension to inhibit an accumulation of substances precipitated from the liquid on the electrode and to remove substances precipitated from the liquid and accumulated on the electrode from the electrode.

2. The electrochemical precipitation reactor of claim 1, wherein the deformation devices are configured to deform the flexible area electrode in that they repeatedly bend the flexible area electrode by at least 4 mm or by at least +/−2 mm related to an extent of the flexible area electrode along its two-dimensional extension of 100 mm.

3. The electrochemical precipitation reactor of claim 1, wherein the deformation devices are configured to deform the flexible area electrode in that they repeatedly bend the flexible area electrode by at least 8 mm or by at least +/−4 mm related to an extent of the flexible area electrode along its two-dimensional extension of 100 mm.

4. The electrochemical precipitation reactor of claim 1, wherein the flexible area electrode is clamped fix in two border regions facing each other across a force application point of the flexible area electrode, and wherein the deformation devices are configured to engage the flexible area electrode in the force application point.

5. The electrochemical precipitation reactor of claim 1, wherein the deformation devices comprise an electromagnetic actuator.

6. The electrochemical precipitation reactor of claim 1, wherein the deformation devices are configured periodically deform the flexible area electrode at a frequency in a range selected from
between 1 Hz and 20 kHz,
between 10 Hz and 10 kHz and
between 50 Hz and 1 kHz.

7. The electrochemical precipitation reactor of claim 1, wherein the flexible area electrode essentially consists of a material having a modulus of elasticity in a range selected from
between 100 MPa and 200 MPa and
between 140 MPa and 190 MPa,
wherein a thickness of the flexible area electrode perpendicular to its two-dimensional extension is at least in one of two ranges
from 0.5 mm to 3 mm and
from 0.5% to 3% of its maximum extent along its two-dimensional extension.

8. The electrochemical precipitation reactor of claim 1, wherein the flexible area electrode is a pump membrane of a membrane pump.

9. The electrochemical precipitation reactor of claim 1, wherein a counter-electrode provided for the electrode comprises a further flexible area electrode ha a two-dimensional extension, and wherein the deformation devices are configured to also deform the further flexible area electrode perpendicular to its two-dimensional extension.

10. The electrochemical precipitation reactor of claim 1, wherein a counter-electrode provided for the electrode comprises a further flexible area electrode essentially having a two-dimensional extension, and wherein a semi-permeable membrane is arranged between the electrode and the counter-electrode.

11. The electrochemical precipitation reactor of claim 1, wherein the flexible area electrode includes a plastic matrix with embedded electrically conductive particles, wherein the flexible area electrode has a smoothly formed surface there, where it gets into contact with the liquid to be treated in the precipitation reactor.

12. An electrochemical precipitation reactor comprising an electrically conductive electrode,
wherein the electrode comprises a flexible area electrode essentially having a two-dimensional extension, which gets into contact with a liquid to be treated in the precipitation reactor,
wherein the flexible area electrode includes a plastic matrix with embedded electrically conductive particles, and
wherein the flexible area electrode has a smoothly formed surface there, where it gets into contact with the liquid to be treated in the precipitation reactor.

13. The electrochemical precipitation reactor of claim 12, wherein the plastic matrix is based on a thermoplastic elastomer, and wherein the electrically conductive particles essentially consist of carbon.

14. The electrochemical precipitation reactor of claim 12, wherein the particles have a particle size in a range selected from
up to 2000 μm,
up to 1500 μm and
or up to 1000 μm.

15. The electrochemical precipitation reactor of claim 12, wherein at least one of electrically conductive fibers and reinforcing fibers are embedded in the plastic matrix.

16. The electrochemical precipitation reactor of claim 12, wherein catalyzer particles are embedded in the flexible area electrode or arranged at the surface of the flexible area electrode there, where the flexible area electrode gets into contact with the liquid to be treated in the precipitation reactor.

17. A method of electrochemically treating a liquid, the method comprising
bringing the liquid into contact with an electrically conductive electrode and an electrically conductive counter-electrode, the electrically conductive electrode comprising a flexible area electrode essentially having a two-dimensional extension,
applying an electric voltage between the electrode and the counter-electrode, and
repeatedly deforming the flexible area electrode perpendicularly to its two-dimensional extension to inhibit the accumulation of substances precipitated from the liquid on the electrode and to remove substances precipitated from the liquid and accumulated on the electrode from the electrode.

18. The method of claim 17, wherein the flexible area electrode, in the step of repeatedly deforming, is repeatedly bent by at least 4 mm or alternately in opposing directions by at least +/−2 mm as related to an extent of the flexible area electrode along its two-dimensional extension of 100 mm.

19. The method of claim 17, wherein the flexible area electrode, in the step of repeatedly deforming, is periodically deformed at a frequency in a range selected from
between 1 Hz and 20 kHz,
between 10 Hz and 10 kHz and
between 50 Hz and 1 kHz.

20. The method of claim 17, wherein the liquid is pretreated by executing the steps of bringing into contact, applying the electric voltage and repeatedly deforming the flexible area electrode, before the liquid is brought into contact with at least one of
further electrodes,
heating elements transferring heat to the liquid,
catalyzers and
filter elements.
